(19) United States
(12) Patent Application Publication
(10) Pub. No.: US 2010/0035212 A1
(43) Pub. Date: Feb. 11, 2010

(54) PREPARATION OF DENTAL IMPLANT SURGERY AND PROSTHESIS INSTALLATION

(76) Inventors: Jean Robichaud, Quebec (CA); Ady Palti, Baden Baden (DE)

Correspondence Address: SUTHERLAND ASBILL & BRENNAN LLP, 999 PEACHTREE STREET, N.E., ATLANTA, GA, 30309, US

(21) Appl. No.: 12/189,461

(22) Filed: Aug. 11, 2008

(51) Int. Cl. A61C 19/00

(52) U.S. Cl. 433/215

(57) ABSTRACT

There are provided a system and a method for assisting a user in preparing a dental implant surgery which includes a prosthesis installation. The system and the method provide a dental implant surgery plan for the user and generate a list of all items required for the dental implant surgery. The items of the list comprise a dental surgical guide, at least one implant and components for at least one prosthesis. The system and the method use a record of suppliers for the items of the list and, for each item of the list, propose to the user a supplier selected among the suppliers of the record. The system and method then allow the user to order all items of the list, which are shipped to the user for the surgery.

### TECHNICAL FIELD

The present relates to dental implant surgery including the prosthesis installation, and more specifically to tools for assisting a dentist in preparing a dental implant surgery.

### BACKGROUND OF THE ART

Dental implant surgery is used to restore lost teeth in a completely or partially edentulous patient. Restoration is performed by drilling a hole in the jaw bone of the patient at the position of the former tooth or teeth, to eventually fix an implant therein. The implant is the piece that is fixed to the jaw bone and that is adapted to receive the prosthesis, i.e. the artificial tooth or teeth, thereon. The prosthesis is then fastened to the implant.

The dental implant surgery comprises several steps carried on and managed by the dentist. The steps typically comprise:

Performing an imprint of the teeth and gum of the patient having some or all teeth missing, as well as a bite registration;

Sending the imprint to a dental laboratory where a dental technician produces a plaster model of the jaws from the imprint, and, if required, a scan prosthesis made from the plaster model;

Scanning the jaws of the patient to produce tomography data of the patient's jaws. If a scan prosthesis is to be used, the patient wears it during the scan.

Planning the position and orientation of the dental implants in the jaw bones using an implant planning software where the jaw bones are shown, to select the position and orientation of the implants to be placed in the jaw bones of the patient;

Ordering the implants and a surgical guide;

When the implants are received, drilling holes in the patient's jaw bones using the surgical guide and installing the implants. A temporary prosthesis may then be installed;

Taking a new imprint of the jaws with the implants in place after a healing period;

Ordering the components of the prosthesis to the dental laboratory where the prosthesis is designed and manually manufactured from the new imprint and using the bite registration; and

Installing the prosthesis on the implants.

Accordingly, a dental implant surgery and prosthesis installation involves multiple parties, i.e. the patient, the dentist and multiple suppliers, such as dental laboratories, dental manufacturing centers, suppliers of implants, etc. Communication between the multiple parties is important since it influences the precision, the success and the quality of the surgery and the esthetic of the restoration. Time coordination of the various steps and parties involved in the steps is also important for time efficiency. This complex process and its timeline are typically mostly managed by the dentist.

### SUMMARY

According to one aspect, there are provided a system and a method for assisting a dentist in preparing a dental restoration including a dental implant surgery and a prosthesis installation.

There are provided a system and a method for assisting a dentist in preparing a dental implant surgery which includes a prosthesis installation. The system and the method are typically implemented as a web portal offering a service of on-demand dental implant surgery planning and of computerized management for assisting the dentist through the steps required to prepare the dental implant surgery. The system and method coordinate the various steps and the interrelation between various parties involved in the dental implant surgery preparation, i.e. the dentists, the denturologists, the dental technician and the other suppliers (suppliers of implants for example).

There are provided a system and a method for assisting a user in preparing a dental implant surgery which includes a prosthesis installation. The system and the method provide a dental implant surgery plan for the user and generate a list of all items required for the dental implant surgery. The items of the list comprise a dental surgical guide, at least one implant and components of at least one prosthesis. It may also comprise drilling instruments. The system and method use a record of suppliers for the items of the list and, for each item of the list, propose to the user a supplier selected among the suppliers of the record. The system and method then allow the user to order all items of the list, which are shipped to the user for the surgery.

The system and method further assist the user in the selection of components to be used in the manufacturing of the prosthesis. The system and method may propose materials to be used for each components of the prosthesis as well as the types of the components according to, for example, budget level preferences.

According to one aspect, there is provided a method for assisting a user in preparing a dental implant surgery on a patient. The method comprises: (a) providing a dental implant surgery plan for the dental implant surgery upon a request from the user and from patient specific data acquired on an area of interest of the jaws of the patient; (b) generating a list of all items required for the dental implant surgery, the items of the list comprising a dental surgical guide, at least one implant and components for at least one prosthesis, specifications of the dental surgical guide being defined at least by the dental implant surgery plan; (c) providing a record of suppliers for the items of the list; and (d) upon receiving an instruction from the user, ordering each item of the list from a corresponding selected supplier selected among the suppliers of the record, all items of the list to be shipped to the user.

According to another aspect, there is provided a system for assisting a user in preparing a dental implant surgery on a patient. The system comprises: a treatment planning center wherein a dental implant surgery plan is made in response to a request from the user and from patient specific data acquired on an area of interest of the jaws of the patient; a list generation unit for generating a list of all items required for the dental implant surgery, the items of the list comprising a dental implant surgical guide, at least one implant and components of at least one prosthesis, specifications of the dental surgical guide being defined at least by the dental implant surgery plan; a record of suppliers for the items of the list; a proposal module for proposing to the user at least one proposed supplier proposed among the suppliers of the record, for each item of the list; and an ordering module for prompting the user to give an instruction to order all items of the list, and for ordering each item of the list from a selected supplier selected among the at least one proposed supplier, all items of the list to be shipped to the user.

According to another aspect, there is provided a method for assisting a user in preparing a dental implant surgery on a patient. The method comprises: (a) obtaining from the user a request for a dental implant surgery plan for the dental implant surgery; (b) prompting the user for inputting a location of patient specific data acquired on an area of interest of the jaws of the patient; (c) prompting the user to input a preplanning comprising an identification of at least one tooth to be restored, a number and a type of implants and a type of prosthesis to be installed during the surgery for a restoration of the at least one tooth; (d) providing the dental implant surgery plan from the data and the preplanning; (e) generating a list of all items required for the dental implant surgery, the items of the list comprising a dental surgical guide, at least one implant and components for at least one prosthesis; (f) providing a record of suppliers for the items of the list; (g) proposing to the user at least one proposed supplier among the suppliers of the record for each item of the list, a selected supplier to be selected among the at least one proposed supplier; (h) prompting the user to give an instruction to order all items of the list; and (i) for each item of the list, ordering the item from the selected supplier, all items of the list to be shipped to the user.

It is noted that throughout the specification, the term “dentist” is meant to include any professional habilitated to perform dental implant surgery, and may actually consist of a team working for and/or around a dentist to prepare and perform dental implant surgery. Such a team may include an assistant, a secretary, multiple dentists, etc.

It is also noted that a dental implant surgery is generally considered throughout the specification to consist of at least an installation of a dental implant directly in the jaw bone of the patient, and of a prosthesis mounted over the dental implant. The term “prosthesis” is meant to indicate the esthetic part of the dental restoration which is to be installed over the dental implant(s) and including an artificial tooth or artificial teeth, a frame such as a bar or a bridge when required. It is noted that, in certain cases, a prosthesis may also use additional structures, such as abutments, which are installed over the implant and over which the prosthesis is mounted.

### BRIEF DESCRIPTION OF THE DRAWINGS

FIG. 1 is a block diagram illustrating a system for assisting a dentist in preparing a dental implant surgery, wherein the interconnection between the various parties is shown;

FIG. 2 is a block diagram illustrating the main modules of an embodiment of a system for assisting a dentist in preparing a dental implant surgery; and

FIG. 3 is a flow chart illustrating the main steps through which the dentist is guided in the preparing of a dental implant surgery, according to an example embodiment of a system for assisting a dentist in preparing a dental implant surgery.

It will be noted that throughout the appended drawings, like features are identified by like reference numerals.

### DETAILED DESCRIPTION

It is first noted that the system and method described herein are not limited to any technique for planning a dental implant surgery or to any technique for manufacturing a surgical guide and a prosthesis. Throughout the description, the following teeth restoration technique will be assumed but it should be understood that the system and method described herein can be adapted for use with any conventional technique or any more advanced technique. For this reason, the planning and manufacturing techniques are not the subject of this description and are not described in details. An outline nonetheless follows.

In order to prepare a dental implant surgery, the patient comes for a first visit at the dentist office. An imprint of the teeth and gum of the patient and a bite registration are taken in the dentist office. The imprint is made by the patient biting into a paste that later hardens to yield an imprint of the jaws of the patient, including the gum and the remaining teeth. It is noted that digital impressions of the jaws may be performed instead of the standard imprint and bite registration. Such a digital impression may be performed using a 3D optical camera for example.

Next, the imprint is sent to a dental laboratory where a dental technician produces a plaster model of the jaws from the imprint, and, if required, a scan prosthesis made from the plaster model. The scan prosthesis and the plaster model are sent to the dentist office. The scan prosthesis may use radiopaque markers for referencing. It is noted that a scan prosthesis is typically used when a large number of teeth is missing in the patient's mouth. If only a few teeth are missing, a scan prosthesis is not required. It is also noted that if digital impressions are used, the step of manufacturing a plaster model may be skipped.

Then, the jaws of the patient are scanned to produce tomography data of the patient's jaws. If a scan prosthesis is to be used, the patient wears it during the scan. The patient may also go to a radiology facility located elsewhere for this step. An apparatus of the type Computerized Tomography scan (CT scan) is typically used at this step. A Volume Tomograph (VT) may also be used.

This completes the prerequisite steps that should be performed before beginning the planning and preparing the dental implant surgery. The following steps are the ones through which the dentist is guided and assisted by the service offered by the access center described herein. These steps are described in more details below.

First, a dental implant surgery planning is performed, i.e. the position and the orientation of the dental implants in the jaw bones are selected using an implant planning software. The software uses a model, typically a three-dimensional model, of the jaw bones provided from the tomography data. The model of the jaw bones is displayed on screen such that it is possible to evaluate the density and quality of the bones. An operator then positions virtual implants in the model of the jaw bones taking into account the density and the quality of the bones. The determined position and orientation of the implants is referred to as the dental implant surgery plan or treatment plan.

Next, items required for the surgery can be ordered. The items include the surgical guide, the components of the prosthesis, the implants and, if required, a kit of drilling instruments required for the surgery. The specifications of the items required are typically determined from the requirements given by the dentist and from the dental implant surgery plan. The surgical guide is the guide that will be installed in the patient's mouth during the surgery to assist the dentist in the drilling of the jaw bones at the right position and orientation for installing the implants. The facility that manufactures the surgical guide typically receives the dental implant surgery plan and the plaster model, and the surgical guide is manufactured accordingly. The facility may rather receive a virtual model of the surgical guide, created from the digital impressions of the jaws and the dental surgery plan, from which the surgical guide is manufactured using a rapid prototyping method such as stereolithography.

In the manufacturing technique assumed herein, the prosthesis is manufactured typically in a dental laboratory, from the plaster model and the dental implant surgery plan. In the dental laboratory, a replica of the jaws of the patient is made (the plaster model may be used as the replica for example) and replicas of implants are installed in the jaw replica. For example, the implants may be installed using the surgical guide already manufactured but other methods may also be used. The prosthesis can then be manufactured using techniques known in the art. It is noted that instead of using the plaster model in the manufacturing the prosthesis, the replica of the jaws may be made from the digital impressions. Other methods for manufacturing the prosthesis may also be used.

The dentist receives all the items required to perform the surgery and install the prosthesis, which is conducted during a next visit of the patient in the dentist office. The prosthesis installed may be a permanent prosthesis or a temporary prosthesis that will be replaced after the jaw bones are completely healed with the implants in place. It is noted that it is also possible to install no prosthesis at this time and to only install the permanent prosthesis later on.

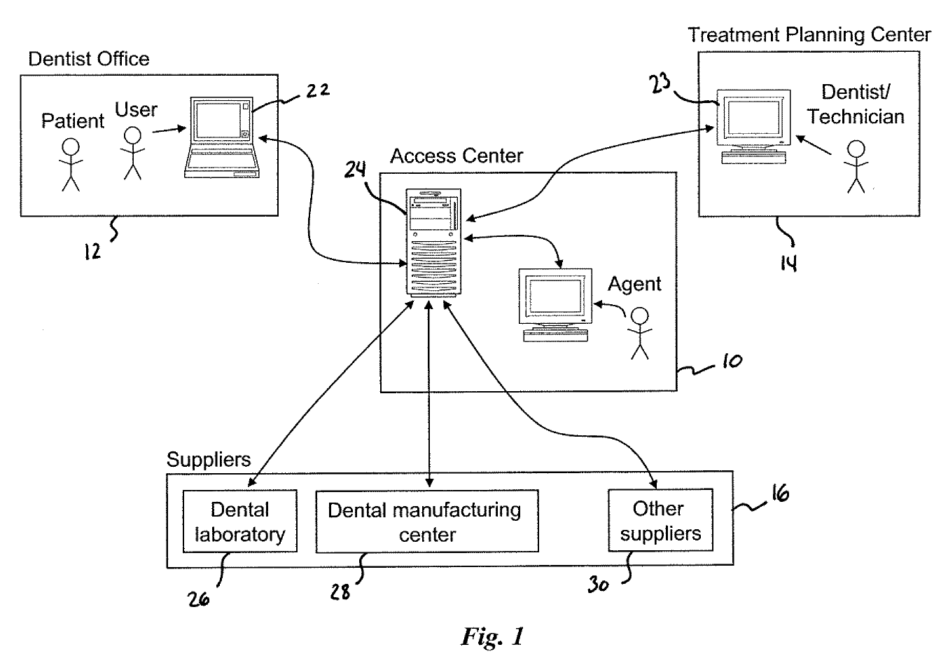

FIG. 1 shows a system for assisting a dentist, or any other user such as a technician or an assistant working with the dentist, in preparing a dental implant surgery, as well as the interaction with the various parties also involved in the preparation of the dental implant surgery. The system has an access center 10 that puts in interrelation the dentist office 12, a treatment planning center 14 and various possible suppliers 16 for the items required for the surgery and for the components of the prosthesis.

The dentist is meeting with the patient on which the dental implant surgery is to be performed, in the dentist office 12. For assistance in preparing the surgery, the dentist is in communication with the access center 10. For instance, the communication may be made through a web portal accessible via the Internet and comprising various web pages to guide the dentist in preparing of the surgery, including the manufacture of the prosthesis. A client software application may also run on a local dentist computer 22 located in the dentist office 12. The client software application then connects to storage medium(s) provided by the access center 10 through a network or an intranet connection, i.e. non-web. A server software application running in the access center 10 and accessed by the dentist through the local computer 22 may also be used.

The system offers various functionalities as described herein below. One of the functionalities is the planning of the treatment including the planning of the position and the orientation of the dental implants to be installed, i.e. the preparation of the dental implant surgery plan. This functionality is typically offered through one or more treatment planning centers 14 which may either be part of or external to the access center 10. It is noted that in another embodiment, the dental implant surgery plan is rather prepared by the dentist himself using an implant planning software provided as a client software or as a server software.

The dentist office 12 has the fixed equipment required to perform all dental implant surgeries but the specific equipment, i.e. items such as the surgical guide, the implants and the prosthesis, required for the specific surgery are to be ordered before the surgery can be performed. The dentist office 12 also has the scan equipment required to acquire digital data on the shape and bone density of the region of interest of the patient's jaw and jaw bones. However, this scan equipment may rather be accessible in a different location where the patient is sent for the scan. In any case, the dentist accesses the access center 10 through the local computer 22 located in the dentist office 12.

The access center 10 typically has a computer system 24 connected to a network for the dentist office 12 to connect thereto. The computer system 24 typically comprises one or more servers to host storage medium(s) and connected in network, and other computer and networking hardware and software components. It will be understood that the access center 10 is accessible to a plurality of dentist offices. Any dentist office may use the service offered by the access center 10 by subscribing to the service. A dentist may subscribe to the service through the network or by phone. An account is created on the computer system 24 for every subscribed dentist office. Furthermore, a new project is also created on the computer system 24 for each dental implant surgery project. Access of a subscribed dentist office is restricted to its own dental implant surgery projects. Dentist offices cannot see projects pertaining to other dentists offices. Some information about the subscribed dentist offices can however be public such that a patient looking for a dentist to make a dental implant surgery can find one by consulting and/or searching a list of dentists that is available on the public web site of the access center 10. It is noted that one dentist office may include a plurality of dentists which may either each have their own subscriptions or have a shared subscription.

A number of access center agents are typically part of the access center 10. The agents typically have a non-restricted access to data in the computer system 24 and can see all projects pertaining to each subscribed dentist offices. Agents can be contacted by phone by the dentists if help is needed with the system for example. As described hereinbelow, while orders to suppliers for a specific dental implant surgery project are typically made electronically through an Internet connection between the computer system 24 and the suppliers 16, access agents may also be involved in making orders to suppliers in some cases, e.g. the given supplier does not have electronic order capabilities. Agents can also negotiate special prices with a supplier, which will be beneficial to all dentists ordering from this supplier.

In one embodiment, the access center 10 includes a plurality of centers located at different locations and interconnected using computer networking. The interconnection is made such that it is quite transparent to the user, i.e. the dentist.

Suppliers 16 include dental laboratories 26, dental manufacturing centers 28 and other suppliers 30. A dental laboratory 26 typically consists of a facility where the plaster model and the scan prosthesis are manufactured from dental imprints. A dental laboratory also manufactures prosthesis. A dental manufacturing center 28 typically manufactures surgical guides. Other suppliers 30 supply the implants and any other required material. It is noted that a single facility may have include both a dental laboratory 26 and a dental manufacturing center 28 while also supplying implants and any other material. It is also noted that the access center 10 may also include a dental laboratory 26, a manufacturing center 28 and/or other suppliers.

The treatment planning center 14 may either be part of or external to the access center 10. It has employees, such as dentists or technicians, who are trained to perform dental implant surgery planning, herein called planning experts. The planning experts use an implant planning software accessed through a local computer system 23, as a client or server software. The implant planning software shows a model of the jaw bones. The planning experts use the implant planning software to position the implants in the model of the jaw bones. In one embodiment, there is a plurality of treatment planning centers 14. A dental laboratory or a dental manufacturing center may also act as a treatment planning center 14. As already mentioned above, in another embodiment the dental implant surgery plan is rather prepared by the dentist himself using an implant planning software provided as a client software or as a server software.

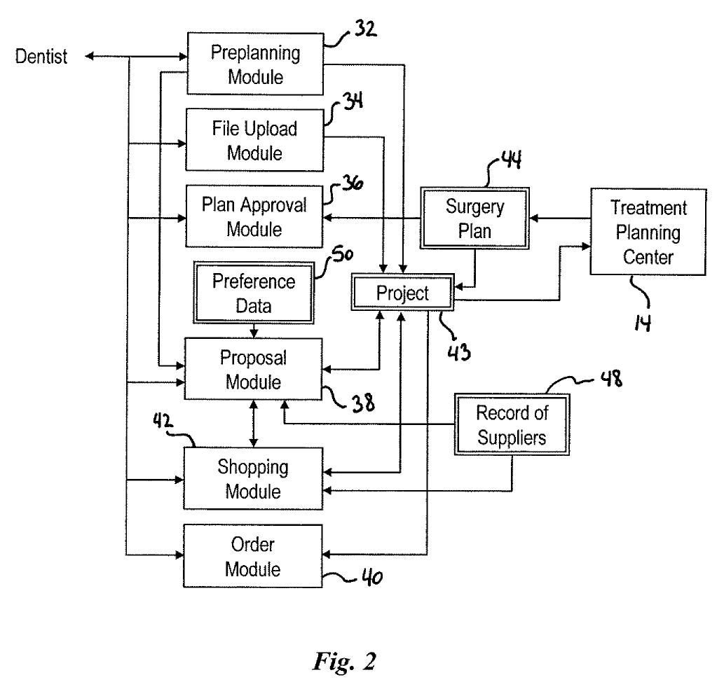

FIG. 2 shows the main modules of an embodiment of the system for assisting a dentist in preparing a dental implant surgery. Using the access center 10, the dentist accesses various modules each interacting with the dentist through a user interface. In the following description, it is assumed that dental implant surgery planning is made at a treatment planning center 14 and not by the dentist himself However, as described above, dental implant surgery planning may rather be performed by the dentist using an implant planning software. As described above, the modules and the user interface may be part of a client software running on the local computer 22, a server software running on the access center 10 or the access center 10 may host a web portal through which the dentist accesses to the various modules. Other implementations of the system, such as hybrid configurations, are also possible. The various modules may include a preplanning module 32, a file upload module 34, a plan approval module 36, a proposal module 38, an order module 40 and a shopping module 42. The system also stores data in storage medium(s). In order to distinguish data from modules on FIG. 2, data units are illustrated with double-line borders while other modules/units are shown with single-line borders. The stored data are shown in FIG. 2 as a project 431 a surgery plan 44, a record of suppliers 48 and dentist's preferences data 50. The project 43, the surgery plan 44 and dentist's preferences data 50 may be stored on the computer system 24 of the access center 10 or on the local computer 22 in the dentist office 12. The record of suppliers 48 may consist of a file such as an Extensible Markup Language (XML) file or a spreadsheet for example and may be stored on the computer system 24 of the access center 10.

The record of suppliers 48 lists data concerning different suppliers 16 such as a plurality of dental laboratories 26, dental manufacturing centers 28 and other suppliers 30. For each supplier 16, the record includes information about its location, address, sales representative contact, etc. For each supplier 16, the record also lists each type of items supplied by that supplier along with, for example, its associated price, delivery time, quality grade, material, other physical properties and any other relevant information. Consequently, the suppliers from which to order the items required for the surgery, including the components of the prosthesis, can be selected from the data listed in the record of suppliers 48.

Each dentist subscribed to the service has given preferences regarding preferred suppliers, preferred materials, etc. Preferences such as supplier preferences, type and material preferences for prosthesis components and implants, as well as other preferences are listed in the dentist's preferences data 50. There are several possibilities to input dentist's preferences in the system. First, a form may be presented to the dentist at subscription. For example, the form may include a list of suppliers for each type of items generally required for a dental implant surgery. The dentist may input suppliers he knows or from which he has ordered in the past. These general preferences may be modified at any time by the dentist and are saved in the preference data 50. Second, for a specific dental implant surgery project, the dentist may input preferences in the preplanning step described below. Project specific preferences may include budget level preferences versus the esthetic of the prosthesis, component and item type preferences (preferred type of implants, e.g. shape and length, and preferred type of abutments for example), material preferences (for prosthesis components and implants) and supplier preferences. Project specific preferences are saved as part of the project 43. The access center 10 may also compile data regarding previous orders and modify or weight dentist's preferences data 50 according to the history or a compilation of orders specific to the dentist.

A new project 43 is created for each dental implant surgery project. Upon creation, the project 43 comprises an identification of the dentist associated with the dental implant surgery project and an identification of the patient such as the patient's name for example. As described below, as the preparation of the dental implant surgery progresses, other data are saved as part of the project 43. Tomography data, a list of items required for the surgery and a selection of suppliers are example of data that are saved as part of the project 43.

Following the creation of a new project 43, the preparation of a dental implant surgery typically begins with a definition of a preplanning through the preplanning module 32. The preplanning module 32 has a preplanning interface prompting the dentist to input preplanning data including, for example, the identification of the tooth or teeth to be replaced in the dental implant surgery, the number of implants, the type(s) of implants to be used, the approximate position(s) of the implant(s), the types of components to be used in the prosthesis and the material of the components. The preplanning data may further include the type of abutments, the material to be used in the various components of the prosthesis, etc. The input of some aspects of the preplanning by the dentist may be optional, letting the system to provide a proposition for this aspect. The preplanning module 32 saves the preplanning data as part of the project 43.

The file upload module 34 allows the dentist to upload the patient specific data file containing the tomography data into the project 43. The file upload module 34 has a file upload interface allowing the dentist to select the proper file in relation to the project 43. The file upload module 34 typically saves the tomography data or a link to the tomography data as part of the project 43. It is noted that the tomography data are saved in a storage medium that may be different from the storage medium where the rest of the project 43 is saved. In this case, a link is established between the location of the tomography data and the rest of the project 43. For example, the location of the tomography data may be saved as part of the project 43 or the location of the tomography data may be predetermined by a reference to the project 43, such as a project number for example.

When the preplanning data and the patient specific data are entered, the dentist may request a dental implant surgery plan to the treatment planning center 14. The request may be made through the access center 10 or directly from the dentist local computer 22 to the treatment planning center 14 using an automatically generated e-mail for example. In this latter case, the e-mail may include the preplanning data. Using the preplanning data and the tomography data, a dental implant surgery planning is prepared according to the requirements given by the dentist in the preplanning. The result of a dental implant surgery planning is a dental implant surgery plan 44.

In one embodiment, the surgery plan 44 is saved on the computer system 24 of the access center 10 by the treatment planning center 14. In other embodiments, the dentist receives the surgery plan 44 from the treatment planning center 14 by e-mail. The surgery plan 44 is then saved locally on the dentist local computer 22.

The plan approval module 36 allows the user to visualize the surgery plan 44 for approval. It has a plan approval interface with a plan display (not shown) displaying the dental implant surgery plan 44. The plan display shows a total or partial representation of the jaw bones of the patient along with virtual implants positioned in the jaw bones. The plan display may also show the remaining teeth. The representation of the jaws and jaw bones typically consists of the tomography data but data processing may be performed on the tomography data to enhance the representation. The plan display may further have an editing function for the dentist to modify the positions and orientations of the implants if required. For example, the plan display may use some features alike an implant planning software or may consist of an implant planning software. The plan display may also only show a two dimensional representation of the jaws and implants, such as one or several digital images. The plan approval interface may use a server software running on the computer system 24 of the access center 10 or on the computer system 23 of the treatment planning center 14, a client software running locally on the dentist local computer 22, or a combination of these possibilities. The dentist then typically approves the dental implant surgery plan 44 through an approval input (not shown) of the plan approval module 36. The approval may consist of an electronic signature entered by way of his username and password. In another embodiment, the dentist prints a legal consent which he signs and sends to the access center 10 by mail of fax.

The plan approval module 36 also allows the dentist to refuse the dental implant surgery plan 44 with notes. A contact, such as the e-mail address and the phone number at the treatment planning center 14 is then typically given to the dentist for direct contact if required. A new dental implant surgery plan 44 may then be prepared and submitted to the dentist through the plan approval module 36.

The proposal module 38 includes a list generation unit (not shown) that automatically generates the list of items required for the surgery. The list of items includes the surgical guide and the specifications required for its manufacture, the implants including the type and possibly the material of the implants, drilling instruments if required and the components and possibly the material of the components of the prosthesis. The list of items is saved as part of the project 43. For some of the items of the list, all specifications are given in the preplanning. However, for some other items, specifications, such as the material for example, may be yet to be determined. The proposal module 38 may assist the dentist in the selection of these specifications.

For example, the proposal module 38 may assist the dentist in the selection of the components of the prosthesis and in selecting materials of some items of the list. For example, the proposal module 38 may assist the dentist in selecting types of components used in the prosthesis by proposing materials for the manufacturing of the components according to budget level preferences and/or material preferences and/or component type preferences provided from preferences data 50. Materials generally used in the manufacturing of the frame of prosthesis include cobalt-chromium alloy, zircon, gold and titanium. The same materials are also generally used in the manufacturing of the abutments. Materials generally used in the manufacturing of the tooth/teeth of prosthesis include ceramic, porcelain and composites. In another embodiment, the proposal module 38 may further suggest the types of components to be used in the prosthesis, including the type of frame, e.g. a bar or a bridge, and the type of abutments, i.e. standard or customized, considering budget level preferences and component type preferences.

Furthermore, for each item of the list, the proposal module 38 selects one or a choice of suppliers among the suppliers of the record 48 for proposal to the dentist. This is made through a proposal interface included in the proposal module 38. The proposal module 38 checks dentist preference data 50 to generate the proposal. It also considers other factors evaluated using data stored in the record 48, such as the availability of the item from the different suppliers, the price of the item, the location of the supplier and the delivery time. If the item is out of stock from a supplier preferred by the dentist or if the delivery time is longer than it should be, the proposal module 38 proposes another supplier. For each item of the list, the proposal module 38 typically proposes one supplier and displays the corresponding price and delivery time. The proposal module 38 may display the location of the supplier for example. The proposal interface may include a pull-down menu allowing the dentist to see alternative suppliers which are also proposed by the system as comparable suppliers. When alternative suppliers are visualized, properties such as their corresponding prices and delivery times are displayed, allowing the dentist to make a selection of supplier.

Accordingly, the dentist is assisted by the proposal module 38 in his or her selection of materials and suppliers for the project 43. When the selection of materials and suppliers is completed, the dentist clicks a confirmation button to confirm the selection of material and suppliers for this specific project 43. The selection of material and suppliers is saved as part of the project 43.

The proposal module 38 may also be linked to a shopping module 42, for the dentist to better compare the various suppliers available and make a good selection. The shopping module 42 has a shopping interface that may list all suppliers supplying one specific item along with the relevant properties such as the price of the item, its delivery time, its quality grade, the location of the supplier, etc., in comparison. The dentist is allowed to select which properties he considers as relevant and which are shown in the shopping interface. The shopping module 42 sorts the list by whichever property is selected by the dentist. For example, the dentist can decide to sort the list from the lowest to the highest price.

The order module 40 allows the dentist to order all the items of the list through an order interface. In one embodiment, when the dentist gives an instruction to order the items, the access center 10 orders each item of the list from the selected suppliers listed in the selection of suppliers. In other embodiments, the order is made directly from the dentist local computer 22 to the suppliers using automatically generated e-mails for example. Each order includes the proper specifications. In the case of the surgical guide, an electronic file including the dental implant surgery plan may be attached to the order or sent on a CD for example. Access agents may also be involved in making orders to suppliers in some cases. Assuming the technique described above for the manufacture of the surgical guide and of the prosthesis, access agents may also be involved in shipping the plaster model and bite registration received from the dentist to the supplier selected for the surgical guide and the prosthesis.

All items required for the dental implant surgery are then shipped to the dentist office 12 when ready. The items may be shipped directly from the suppliers to the dentist office 12 or may be first shipped to the access center 10 where agents packages the items in a single package before shipping it to the dentist office 10.

### EXAMPLE

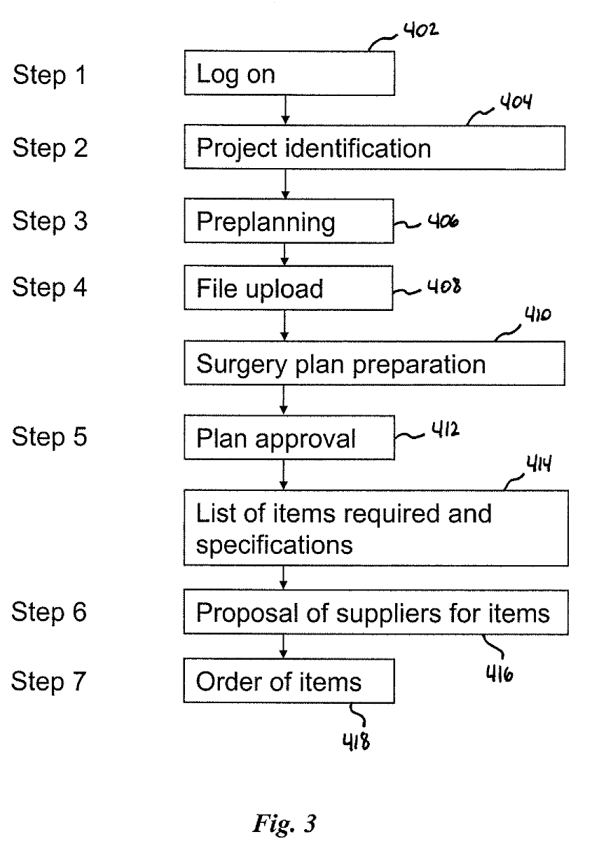

An example embodiment of the system of FIG. 2 is now described with reference to FIG. 3. In this example, the access center 10 hosts a web portal through which the dentist connects to the access center 10. The web portal shows to the dentist as a user interface which is divided in a number of sub-interfaces representing the various steps through which the dentist is guided for preparing a dental implant surgery. In the embodiment of FIG. 3, some of the sub-interfaces correspond to the interface of the modules 32, 34, 36, 38, 40 and 42. Also in the embodiment of FIG. 3, the record of suppliers 48, the project 43, the surgery plan 44 and the preference data 50 are typically saved on the computer system 24 of the access center 10

The user interface and its various sub-interfaces are now described with reference to both FIGS. 2 and 3. FIG. 3 illustrates the main steps through which the dentist is guided in preparing a dental implant surgery. The dentist is guided through the steps via the user interface. The user interface has a sub-interface for each step and switches from the current step to the following step when the current step is completed. Prior to log on to the access center 10 for planning and preparing a dental implant surgery, the tomography data of the patient jaws is typically completed and the tomography data is stored on the dentist's computer or on any other data storage means.

In step 1 which corresponds to box 402, the dentist logs on the access center 10. Log on is typically accessed through the home page of the web portal. A pre-subscribed dentist enters his username and password. Subscription is also accessible through the home page.

In step 2 corresponding to box 404, the list of dental surgery projects pertaining to the dentist is displayed. Both ongoing and completed (order completed) projects are typically listed, along with their respective status. Ongoing projects correspond to projects for which the items required for the surgery are not yet ordered. The dentist may select an ongoing project to complete the steps and eventually order the items required, may visualize a completed project for reference or may create a new project. When creating a new project 43, the dentist inputs data concerning the patient. Patient data is used to associate a patient with the right project for later reference. The system attributes a reference number to the project 43.

In one embodiment, the user interface asks the dentist to ship the plaster model or the imprints and the bite registration to the access center 10 and indicates the address to which the package should be shipped and the reference number that is to be indicated on the package for association with the proper project 43 at the access center 10. It is however noted that if a digital impression is available in replacement of the plaster model, such a digital impression can be transferred to the access center 10 via the user interface, or can be sent using an-email for example.

In step 3 corresponding to box 406, preplanning data is input by the dentist using the preplanning interface of the preplanning module 32. The preplanning interface displays a general diagram of teeth of the upper and the lower jaw for the dentist to select the teeth to be replaced in the dental implant surgery. Teeth are selected by simply clicking on the proper teeth. The preplanning interface also has a form through which the number and the type of implants to be used are entered. The types of components of the prosthesis, e.g. the type of frame and the type of abutment, is also entered using the form. The materials to be used for the various items and components may also optionally be entered. As mentioned above, project specific preferences may also be entered at this step, such as budget level preferences, material preferences, component and item type preferences and supplier preferences for the specific project. The preplanning data is then uploaded to the access center 10 and saved as part of the project 43. The combination of steps 2 and 3 is considered to form a request for a dental implant surgery.

In step 4 corresponding to box 408, the user is prompted by the file upload interface of the file upload module 34 to upload the patient specific data file containing the tomography data. The file is typically saved at the access center 10 as part of the project 43.

The dental implant surgery plan is now ready to be prepared. The access center 10 then directs the request for a dental implant surgery plan to a treatment planning center 14 and a planning expert is assigned to the project. In one embodiment, the direction and assignment is made automatically by the server of the access center 10. In another embodiment, an agent of the access center 10 makes the direction and assignment.

In a step that is transparent to the user and corresponding to box 410, the tomography data and the preplanning is loaded in the implant planning software for the planning expert to perform the dental implant surgery planning according to the requirements given by the dentist in the preplanning. The result of a dental implant surgery planning is a dental implant surgery plan 44 which is uploaded from the treatment planning center 14 to the access center 10, and saved as part of the project 43. The dental implant surgery plan 44 is typically a machine-type file that defines the positions and the orientations of the implants and from which the surgical guide is manufactured by a machine receiving the file.

In step 5 corresponding to box 412, a plan approval interface of the plan approval module 36 indicates to the dentist when the dental implant surgery plan 44 is ready for approval and displays the dental implant surgery plan 44 for visualization and approval by the dentist. In this embodiment, the display uses a server software running on the access center 10. The dentist then typically approves the dental implant surgery plan 44 through the plan approval interface. In this embodiment, the approval typically consists of an electronic signature entered by way of his username and password.

As noted above, the plan approval module interface 36 also allows the dentist to refuse the dental implant surgery plan 44.

It is noted that if the dentist logs off the access center 10 before the dental implant surgery plan is ready, when logging in again he is allowed to see the status of the project, i.e. dental implant surgery plan in process or ready, in the interface of step 404. In one embodiment, the dentist also receives an e-mail to notify that the dental implant surgery plan is ready.

In box 414, the access center 10 generates the list of items and corresponding item specifications 46 required for the surgery. The list of items 46 includes the surgical guide and the specifications required for its manufacture, the implants including the type of implants, drilling instruments and the components of the prosthesis. The list of items is generally generated from the preplanning data which defines the number and the type of implants as well as the type of the prosthesis. The specifications 46 of the surgical guide are defined by the dental implant surgery plan.

In step 6, box 416, one or a choice of suppliers selected among the suppliers of the record 48 is proposed to the dentist for each item of the list 46. This is made through the proposal module 38. The proposal interface 38 checks dentist preference data 50 and also considers other factors evaluated using data stored in the record 48, such as the availability of the item from the different suppliers, the price of the item and the delivery time. When completed, the dentist clicks a confirmation button to confirm the selection of suppliers for this specific project 43. The selection of suppliers 52 is saved in the access center 10, as part of the project 43.

In this example, the proposal module 38 further assists the dentist in the selection of the components used in the prosthesis by proposing materials for the manufacturing of the artificial teeth/tooth, the frame and the abutment of the prosthesis, taking into account the budget level preferences and/or the material preferences and/or component and item type preferences provided from preplanning data.

In step 6, the proposal interface also offers the option to go to another page, i.e. the shopping module 42, for the dentist to better compare the various suppliers available and make a good selection.

In step 7, box 418, the dentist is prompted to give an instruction to order all the items of the list through the order interface of the order module 40. When the instruction is given, the access center 10 orders each item of the list from the selected suppliers listed in the selection of suppliers 52. Each order includes the proper specifications. In the case of the surgical guide, an electronic file including the dental implant surgery plan is attached to the order or sent on a CD for example. The orders are typically made automatically by the computer system 24 of the access center 10 which makes an electronic order via an Internet connection between the server and the suppliers 16. Access agents may also be involved in making orders to suppliers in some cases. Assuming the technique described above for the manufacture of the surgical guide and of the prosthesis, access agents may also ship the plaster model received from the dentist to the supplier selected for the surgical guide and the prosthesis, when required by the supplier.

The items are typically shipped to the access center 10 where an agent packages all the items required for the surgery in a single package which is shipped to the dentist office 12. The dentist then receives a single package and knows, when receiving the package, that all items required for the surgery are there. This relieves the dentist from compiling the receipt of the items. When the package is received, the dentist, or his secretary, simply presumes that everything is ready for the surgery and confirms the time of the surgery with the patient. The package still includes a checklist of the items it should include which is may be used by the dentist to check the content of the package before the surgery.

It is noted that the web portal described herein may also have a section directed to dental laboratories for the dental laboratories to subscribe to the access center 10 such that they are registered in the record of suppliers 48. Using this last section of the web portal, registered suppliers may also enter and modify prices, delivery time, and other data concerning the items supplied. The web portal may also have a section directed to patients for giving information about dental implant surgeries. This last section may also list dentists that are subscribed to the access center and/or suggest to the patient one or more subscribed dentists located in his/her neighborhood.

It is also noted that the access center 10 may further include a supplier evaluation module for compiling an evaluation of the quality of the products supplied and the quality of the service offered by each supplier. For example, evaluations may be provided from users e.g. dentists, of the access center 10 who have purchased from evaluated suppliers, or from agents of the access center 10 where products have transited. The proposal of suppliers may then be further made according to the compiled evaluations.

The system and method herein described assists the dentist in ordering all the items required for the dental implant surgery, such as the surgical guide, the implant(s) and the components of the prosthesis. It will however be understood that system and method also allows the dentist to only order one or some of the items if this is what he or she wishes. Accordingly, the dentists may only order the surgical guide for example.

It is noted that the system software may be implemented in various ways. In one embodiment, the access center 10 consists of a web portal accessed by the dentist using a computer 22 located at the dentist office 12 and connected to the access center 10 through the Internet. In another embodiment, a client software may be installed on the computer 22 located at the dentist office 12, the client software being in contact with the access center 10 to access the storage medium(s) and to order required items. In another embodiment, a combination of both a server and a client software is used.

Furthermore, when performing the dental implant surgery planning, the implant planning software typically runs on a computer system 23 located in the treatment planning center 14. However, in another embodiment the implant planning software rather runs on the local computer 22 located in the dentist office 12 and is remotely accessed by the planning experts. This eliminates the need for tomography data file transfer.

It will be understood that the system and method described herein may be used for both partial and complete dental restoration.

While illustrated in the block diagrams as groups of discrete components communicating with each other via distinct data signal connections, it will be understood by those skilled in the art that the illustrated embodiments may be provided by a combination of hardware and software components, with some components being implemented by a given function or operation of a hardware or software system, and many of the data paths illustrated being implemented by data communication within a computer application or operating system. The structure illustrated is provided for efficiency of teaching the described embodiment.

The embodiments described above are intended to be exemplary only. The scope of the invention is therefore intended to be limited solely by the appended claims.

What is claimed is:

1. A method for assisting a user in preparing a dental implant surgery on a patient, the method comprising:
providing a dental implant surgery plan for said dental implant surgery upon a request from the user and from patient specific data acquired on an area of interest of the jaws of the patient;
generating a list of all items required for the dental implant surgery, the items of the list comprising a dental surgical guide, at least one implant and components for at least one prosthesis, specifications of the dental surgical guide being defined at least by said dental implant surgery plan;
providing a record of suppliers for the items of the list; and
upon receiving an instruction from the user, ordering each item of the list from a corresponding selected supplier selected among the suppliers of the record, all items of the list to be shipped to the user.

2. The method as claimed in claim 1, further comprising: for each item of the list, proposing to the user at least one proposed supplier among the suppliers of the record, the selected supplier to be selected among the at least one proposed supplier.

3. The method as claimed in claim 2, wherein proposing to the user at least one proposed supplier is made at least according to user preferences regarding the suppliers.

4. The method as claimed in claim 1, wherein said generating comprises proposing at least one of types of said components and materials of said components for the at least one prosthesis according to at least one of budget level preferences, component type preferences and material preferences.

5. The method as claimed in claim 2, wherein the step of providing a record of suppliers comprises: providing in the record the types of the supplied items supplied by each suppliers of the record, the materials of the supplied items and properties of the supplied items, and wherein proposing to the user at least one proposed supplier is made according to said properties.

6. The method as claimed in claim 2, further comprising: prompting the user to select the selected supplier among the at least one proposed supplier.

7. The method as claimed in claim 5, further comprising: for at least one item of the list, displaying the properties of the supplied items in comparison to allow the user to select the selected supplier for the at least one item, based on said comparison.

8. The method as claimed in claim 1, further comprising: displaying the dental implant surgery plan for visualization and approval by the user.

9. The method as claimed in claim 1, wherein the step of providing the dental implant surgery plan comprises: prompting the user with a preplanning interface for the user to input a preplanning, the preplanning comprising at least one of an identification of at least one tooth to be restored, a number of implants, a type of implants, an approximate position of implants, types of components for the prosthesis, materials of components for the prosthesis and budget level preferences.

10. The method as claimed in claim 9, wherein the step of generating a list of all items required for the dental implant surgery is made using at least said preplanning.

11. The method as claimed in claim 1, wherein the step of providing the dental implant surgery plan comprises: prompting the user to input a location of the patient specific data acquired on an area of interest of the jaws of the patient.

12. The method as claimed in claim 1, further comprising: receiving said all items of the list, packaging the received items in one package and shipping said package to the user.

13. A system for assisting a user in preparing a dental implant surgery on a patient, the system comprising:
a treatment planning center wherein a dental implant surgery plan is made in response to a request from the user and from patient specific data acquired on an area of interest of the jaws of the patient;
a list generation unit for generating a list of all items required for the dental implant surgery, the items of the list comprising a dental implant surgical guide, at least one implant and components of at least one prosthesis, specifications of the dental surgical guide being defined at least by said dental implant surgery plan;
a record of suppliers for the items of the list;
a proposal module for proposing to the user at least one proposed supplier proposed among said suppliers of the record, for each item of the list; and
an ordering module for prompting the user to give an instruction to order all items of the list, and for ordering each item of the list from a selected supplier selected among the at least one proposed supplier, all items of the list to be shipped to the user.

14. The system as claimed in claim 13, further comprising: a preferences register for registering preferences of the user regarding the suppliers of the record, for the proposal module to propose at least one proposed supplier according to at least said preferences.

15. The system as claimed in claim 13, wherein the record of suppliers comprises the types of the supplied items supplied by each suppliers of the record, the materials of the supplied items and properties of the supplied items, for the proposal module to propose at least on proposed supplier according to at least said properties.

16. The system as claimed in claim 15, wherein said properties comprises at least one of a price, a delivery time and a quality grade of the supplied items.

17. The system as claimed in claim 13, further comprising: a preferences register for registering at least one of budget level preferences, component type preferences and material preferences, the list generation unit to propose at least one of types of said components and materials of said components for the at least one prosthesis according to said at least one of budget level preferences, component type preferences and material preferences.

18. The system as claimed in claim 14, wherein said proposal module comprises a selection option allowing the user to select said selected supplier among the at least one proposed supplier.

19. The system as claimed in claim 13, further comprising: a shopping module with a comparing display showing, for at least one item of the list, the properties of the supplied items in comparison to allow the user to select said selected supplier for the at least one item, based on said comparison.

20. The system as claimed in claim 13, further comprising a plan approval module having a plan display to display the dental implant surgery plan for visualization by the user, and an approval input for obtaining an approval by the user.

21. The system as claimed in claim 13, further comprising a preplanning module for the user to input a preplanning, the preplanning comprising at least one of an identification of at least one tooth to be restored, a number of implants, a type of implants, an approximate position of implants, types of components for the prosthesis, materials of components for the prosthesis and budget level preferences.

22. The system as claimed in claim 21, wherein said list generation unit generates the list of all items using at least said preplanning.

23. The system as claimed in claim 13, further comprising a web portal in communication with said user through the internet, and allowing the user to access to the treatment planning center, the proposal module and the ordering module.

24. The system as claimed in claim 13, wherein patient specific data comprises a Computed Tomography (CT) scan.

25. The system as claimed in claim 13, further comprising a file upload module for the user to input a location of said patient specific data acquired on an area of interest of the jaws of the patient.

26. A method for assisting a user in preparing a dental implant surgery on a patient, the method comprising:
obtaining from the user a request for a dental implant surgery plan for said dental implant surgery;
prompting the user for inputting a location of patient specific data acquired on an area of interest of the jaws of the patient;
prompting the user to input a preplanning comprising an identification of at least one tooth to be restored, a number and a type of implants and a type of prosthesis to be installed during the surgery for a restoration of said at least one tooth;
providing said dental implant surgery plan from said data and said preplanning;
generating a list of all items required for the dental implant surgery, the items of the list comprising a dental surgical guide, at least one implant and components for at least one prosthesis;
providing a record of suppliers for the items of the list;
proposing to the user at least one proposed supplier among the suppliers of the record for each item of the list, a selected supplier to be selected among the at least one proposed supplier;
prompting the user to give an instruction to order all items of the list; and
for each item of the list, ordering the item from the selected supplier, all items of the list to be shipped to the user.
